(19) United States
(12) Patent Application Publication
(10) Pub. No.: US 2010/0094740 A1
(43) Pub. Date: Apr. 15, 2010

(54) FINANCIAL PLANNING AND PLAN EXECUTION

(75) Inventor: Brian Richter, Woodbine, NJ (US)

Correspondence Address: CONLEY ROSE, P.C.;David A. Rose, P. O. BOX 3267, HOUSTON, TX, 77253-3267, US

(73) Assignee: CashLocale.com Inc., Woodbine, NJ (US)

(21) Appl. No.: 12/251,059

(22) Filed: Oct. 14, 2008

(51) Int. Cl. G06Q 40/00

(52) U.S. Cl. 705/35

(57) ABSTRACT

A computer-readable medium stores software that, when executed by a processor, causes the processor to create a financial plan for a user based on financial information provided by at least one of a plurality of financial institutions and the user; retrieve updated data regarding the user provided by at least one of the plurality of financial institutions; compare the data with the plan; output for display the comparison; and schedule at least one transaction with at least one of the plurality of financial institutions based on the comparison.

### CROSS-REFERENCE TO RELATED APPLICATIONS

Not applicable.

### BACKGROUND

The proliferation of financial transactions possible over the Internet is overwhelming users. Specifically, users must remember a username and password for every creditor, debtor, or entity to whom the user gives funds or from whom the user receives funds. Considering users submit funds for utilities, mortgages, automobiles, phones, and credit cards on top of monitoring funds in bank accounts, retirement accounts, and investment accounts, users are hard-pressed to plan and execute a coherent financial strategy to manage debt and equity.

### SUMMARY

Systems, methods, and computer-readable mediums for financial planning and plan execution are described herein. In at least one embodiment, a computer-readable medium stores software that, when executed by a processor, causes the processor to create a financial plan for a user based on financial information provided by at least one of a plurality of financial institutions and the user; retrieve updated data regarding the user provided by at least one of the plurality of financial institutions; compare the data with the plan; output for display the comparison; and schedule at least one transaction with at least one of the plurality of financial institutions based on the comparison.

In another embodiment, a method includes creating a financial plan for a user based on financial information provided by at least one of a plurality of financial institutions and the user; retrieving updated data regarding the user provided by at least one of the plurality of financial institutions; comparing the data with the plan; displaying the comparison; and scheduling at least one transaction with at least one of the plurality of financial institutions based on the comparison.

In yet another embodiment, a system includes a processor and memory coupled to the processor. The processor creates a financial plan for a user based on financial information provided by at least one of a plurality of financial institutions and the user; retrieves updated data regarding the user provided by at least one of the plurality of financial institutions; compares the data with the plan; outputs for display the comparison; and schedules at least one transaction with at least one of the plurality of financial institutions based on the comparison.

These and other features and advantages will be more clearly understood from the following detailed description taken in conjunction with the accompanying drawings and claims.

### BRIEF DESCRIPTION OF THE DRAWINGS

For a more complete understanding of the present disclosure, reference is now made to the accompanying drawings and detailed description, wherein like reference numerals represent like parts:

FIG. 1A illustrates a financial planning and plan execution system in accordance with at least one embodiment;

FIG. 1B illustrates a financial planning and plan execution system in accordance with at least one embodiment;

FIG. 1C illustrates a financial planning and plan execution system in accordance with at least one embodiment;

FIG. 2 is an organizational chart illustrating features of financial planning and plan execution in accordance with at least one embodiment; and

FIG. 3 illustrates a method of financial planning and plan execution in accordance with at least one embodiment.

### NOTATION AND NOMENCLATURE

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean an optical, wireless, indirect electrical, or direct electrical connection. Thus, if a first device couples to a second device, that connection may be through an indirect electrical connection via other devices and connections, through a direct optical connection, etc. Additionally, the term “system” refers to a collection of two or more hardware components, and may be used to refer to an electronic device.

A “user” is defined as a person, multiple people, or an entity, e.g. a business, that utilizes the financial planning and plan execution systems, methods, or computer-readable mediums disclosed.

A “financial institution” is defined as a creditor of the user, a debtor of the user, or any person, group of people, or entity to whom the user gives funds or from whom the user receives funds.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one having ordinary skill in the art will understand that the following description has broad application, and the discussion of any embodiment is meant only to be exemplary of that embodiment, and not intended to intimate that the scope of the disclosure, including the claims, is limited to that embodiment.

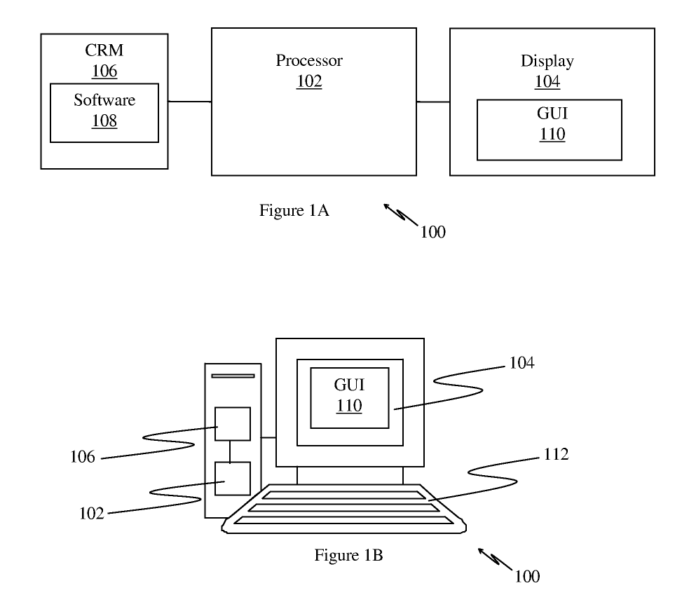

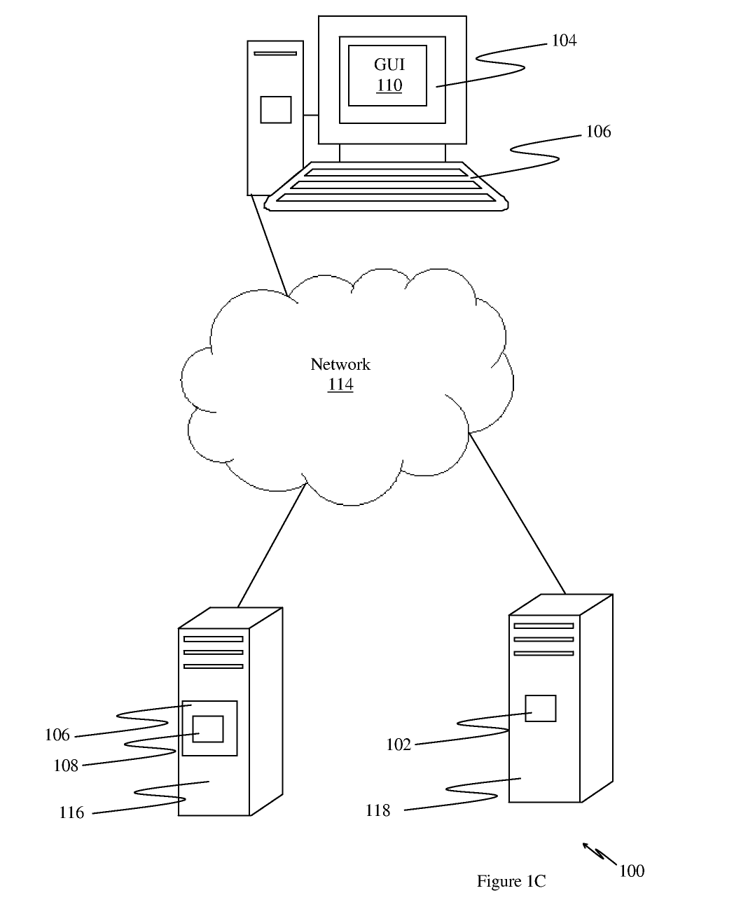

To overcome the obstacles outlined above, computer-readable mediums, systems, and methods of financial planning and plan execution are disclosed. FIG. 1A illustrates a system 100 comprising a computer-readable medium 106 storing software 108 that, when executed by a processor 102, causes the processor 102 to perform any of the steps described in this disclosure. In at least one embodiment, the system 100 also comprises a graphical user interface (“GUI”) 110 presented on a display 104. The GUI 110 is the point of access between the user and the system 100, and the GIU 110 preferably displays any of the comparisons, variables, values, plans, and sub-plans described below both in graphical and textual formats.

FIG. 1B illustrates the system 100 in at least one embodiment. Specifically, the processor 102 is a computer processor, and the computer-readable medium 106 is coupled to the processor 102 in a computer. Preferably, the GUI 110 is the latest version of Internet Explorer (“IE”) or any other browser. The display 104 is a computer monitor, and a user can manipulate the GUI 110 via the keyboard 112 and computer mouse (not shown). In such an embodiment, the processor 102 and computer-readable medium 106 are local. Turning to FIG. 1C, components of the system 100 are distributed over a network 114 in at least one embodiment. Specifically, the user interacts with the GUI 110, and transmits information over the network 114 for processing by servers 116, 118. The servers 116, 118 take the information as input and transmit information as output over the network 114 for display by the GUI 110. Preferably, the network 114 is the Internet, and the GUI 110 display websites from the World Wide Web. Server 118 comprises a processor 102 that executes software 108 located on a computer-readable medium 106 of server 116. Many configurations and combinations of distributed computing are possible.

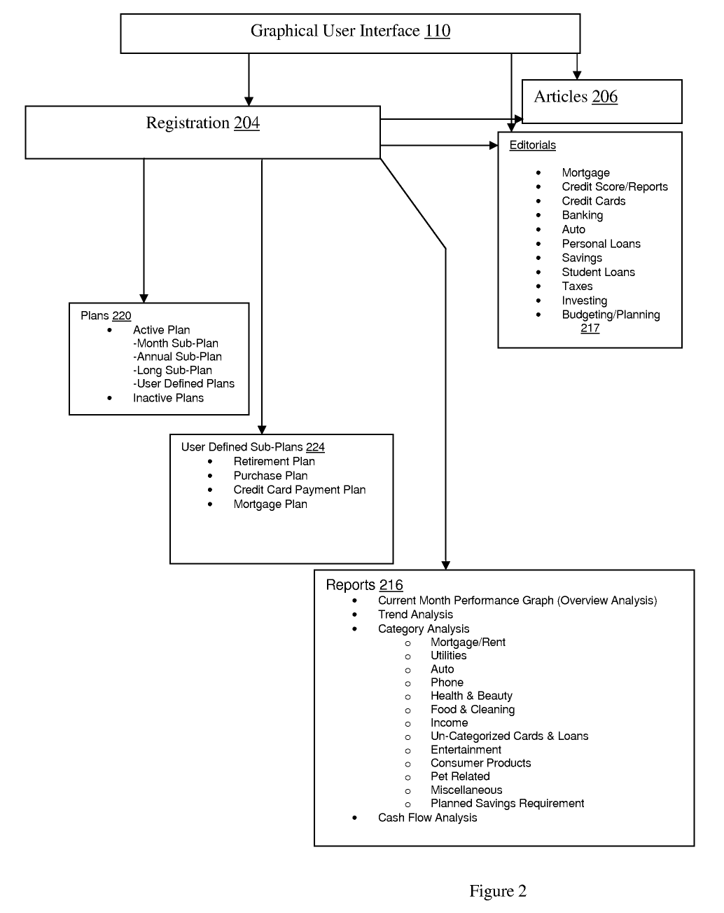

FIG. 2 is an organizational chart illustrating features of financial planning and execution in accordance with at least one embodiment. Using the GUI 110, the user can plan and execute a financial strategy, analyze performance of the planning and execution, and adjust the planning and execution accordingly.

Registration

The user preferably registers 204 with the system 100. In at least one embodiment, registration comprises the user clicking a registration link and submitting any or all of: first name, middle name, last name, address, pin code, email address, date of birth, gender, occupation, education level, interests, phone numbers, fax numbers, username, passwords, secret question, and answer to the secret question. The system 100 preferably validates any or all of this information. In at least one embodiment, the user also provides financial information during registration. Specifically, the user provides any or all of: name of financial institution, authorization information, type of account with the financial institution, description of the account, and account number or partial account number. For example, the financial institution is a bank named Big Bank, the authorization information is the user's username and password to access Big Bank's website or a code provided by Big Bank, the type of account is a checking account, the description of the account is “User's Bank Account: All Expenses Paid from Here,” and the account number or partial account number is the checking account number associated with the user's checking account. Many values for these inputs are possible, e.g. the type of account may be saving, credit card, loan, retirement, investment, etc., and the user preferably inputs information for a plurality of financial institutions. Based on the values input, the system 100 may ask for follow-up information. For example, if the type of account is a 401(k) account, the system 100 prompts the user to enter a tax rate and employer match value in order to calculate a true investment return rate. After successful registration, the user is able to login to the system 100 at any time using the username and password selected during registration. Preferably, an email is sent to the user's email address confirming successful registration. Once input, the financial information, including the authorization information (e.g. username and password for the bank), need not be input again. Rather, the system 100 stores this information securely, and the user logs in to the system 100 using only the username and password selected during registration for access to all of the user's financial institutions including executing transactions. Manual addition of accounts by the user can be executed at any time.

Preferably, the processor 102 is caused to create a financial plan for the user based on the financial information provided by at least one of a plurality of financial institutions and the user. Preferably, the financial plan comprises at least one estimated financial outflow of the user and at least one estimated financial inflow of the user. First, the system 100 requests information regarding the user's financial outflows and inflows (“flows”) based on the financial information provided by the user. Specifically, the system 100 uses any or all of: the name of financial institution, authorization information, type of account with the financial institution, and the account number or partial account number to request flow information. The financial institutions preferably provide the flow information. In at least one embodiment, the information regarding the flows is provided by the financial institutions to a third party, and the system 100 retrieves the information from the third party to create and populate a database associated with the user. The database is maintained, manipulated, and backed up by the system 100, and the data for the various comparisons, variables, values, plans, and sub-plans described below reside in the database.

Second, the user's financial outflows are associated with categories of financial outflow without input from the user based on the data provided by the financial institutions. For example, a credit provider provides a list of the user's credit card transactions. The system 100 identifies a particular transaction (financial outflow) with a grocery store. The system 100 associates the transaction with the category “food expense.” Other categories of financial outflow comprise any or all of: mortgage/rent, utilities, automobile, phone, healthcare, credit card, loan, entertainment, retail, pet, planned savings, miscellaneous, etc.

Third, the user's financial inflows are similarly associated with categories of financial inflow without input from the user based on the data provided by the financial institutions. For example, an investment bank provides a statement of dividends for the user's investments each quarter. The system 100 associates a quarterly dividend deposit into the user's account at the investment bank (financial inflow) with the category “dividends.” Other categories of financial inflow comprise any or all of: employment, investment, miscellaneous, etc.

The associations preferably occur without any input from the user. Preferably, popular categories are predetermined by a system administrator, and all categories are configurable to the user's needs. Also, the user is able to configure the associations manually if desired. For example, the system 100 associates a restaurant bill (financial outflow) with the category “food expense.” The user does not wish restaurant bills to be categorized as a food expense because the user believes restaurant expenses is one area where the user can reduce outflows if needed, and the user would only rarely consider reducing food expense outflows. As such, the user manually changes the category associated with the restaurant bill to be “entertainment expense,” a category the user considers first when needing to reduce outflows. The system 100 will consequently categorize any future restaurant bills as an entertainment expense and re-categorize past and present restaurant bills as entertainment expenses.

Any flows the system 100 is unable to categorize can also be categorized manually by the user using the predetermined categories or categories unique to the user. Preferably, the user also has the ability to split a flow into multiple different categories and/or multiple sub-flows. For example, if an automatic teller machine (“ATM”) withdrawal (financial outflow) of $300.00 is provided as one outflow, the user can split the outflow into two sub-flows and categorize one $200.00 sub-flow under “fuel expense” and another $100.00 sub-flow under “entertainment expense.” Preferably, the user can click on any flow category in the financial plan and see the flows associated with that category. For those accounts that are not currently online or for those financial institutions unable to provide the financial data, the user can enter the flow information, normally provided by the financial institutions, manually.

Fourth, future flows are estimated based on the flow data as well as configurable values able to be set by the user or a system administrator. For example, the values for retirement age and the amount of equity needed at retirement are configurable, but have a default value set by a system administrator. Preferably, future flows are estimated based on configurable formulas, the formulas comprising configurable variables. Preferably, only system administrators can configure the formulas. In at least one embodiment, the financial plan comprises a short-term financial sub-plan, a medium-term financial sub-plan, and a long-term financial sub-plan 220. In at least one embodiment, the short term sub-plan comprises the flows estimated for the next thirty days or until the end of the current month. Similarly, the medium-term sub-plan comprises the flows estimated for the 3 months, and the long-term sub-plan comprises the flows estimated for a year. The amount of time each sub-plan covers is configurable by the user.

System administrators are able to access the system 100 as well. An administrator is able to define the type of account that can be loaded into the system 100, define the default values of any configurable values, create the flow categories mentioned above, and define the data required as input by the user in order to create or execute a plan or sub-plan. The configurable values comprise any or all of: rate of inflation, age of retirement, months of emergency savings, annual income increase, etc. The system administrator can also add and remove education materials, forms, posts, and messages from the system 100. Preferably, the administrator accesses the system 100 via a GUI. In at least one embodiment, the administrator also resolves troubleshooting issues and sets a period for the system 100 to refresh the database associated with the user.

As part of the refresh, the processor 102 is caused to retrieve updated data regarding the user provided by at least one of a plurality of financial institutions. Preferably, the updated data is flow data that has been updated since the last refresh or since the initial creation of the database. As such, the database of historical flow data, integrating the updated data, is updated by the system 100. The processor is caused to compare the historical flow data (actual flow information) with the plan (previously estimated flow information), and output for display the comparison. Such outputs preferably take the form of reports 216. Preferably, the reports use visual cues to convey information to the user quickly. For example, the comparison between actual and previously estimated flow information is color coded in at least one embodiment. The color red is used to denote that the user's outflows are greater than estimated or that the user's inflows are less than estimated, indicating an underperforming divergence from the plan. Conversely, the color green is used to denote that the user is performing better than the plan. Many such visual cues are possible.

The user can create, or have the system 100 automatically create, additional financial plans. Preferably, only one plan is active at a time. The currently executing financial plan is termed the “active plan,” while plans currently not being executed are termed “inactive plans” 220. As desired, the user can toggle between various inactive plans in order to make them active. Preferably, a financial sub-plan comprises at least one estimated financial outflow and inflow of the user regarding a particular topic or time horizon. Preferably, the future flows are estimated based on configurable formulas, the formulas comprising configurable variables, and only system administrators can configure the formulas. In at least one embodiment, the processor 102 is caused to modify the financial plan with at least one sub-plan. For example, a sub-plan may be added to a plan or deleted from a plan. The impact of adding or deleting a sub-plan on the financial plan may be viewed before actual addition or deletion of the sub-plan, making the sub-plans useful as a financial planning tool. A user views the impact of adjusting the active plan via a sub-plan to prevent any inadvertent transactions or the inadvertent scheduling of any transactions based on execution of the sub-plan as part of the active plan. In addition to the short, medium, and long-term financial sub-plans, various other sub-plans 224 can be added and deleted from a financial plan, including the active plan, on demand in a modular fashion. These other sub-plans are termed “user-defined sub-plans.”

Short-Term Sub-Plan

Preferably, the short-term sub-plan 220 helps the user plan, manage, analyze, and execute financial flows for the near future. Such financial flows usually consist of monthly bills. Preferably, the user selects a default financial institution, usually a bank, to pay bills from. However, the user may select to pay bills from any of the user's financial institutions. In addition to displaying the amount and due date of each bill, the system 100 maintains the status of each bill. For example, the status of a particular bill may be “Due on July 4,” “Scheduled for payment,” or “Paid.” Preferably, the system 100 notifies the user via email before each bill is due. Should a financial institution be unable to provide information about the bill, the amount of each bill is estimated based on previous outflows from, e.g. the bank, until the bill is paid. The user can add or delete bills and change the date for payment for each bill as necessary. In at least one embodiment, the user can select settings such that the processor 102 schedules payment for a bill and pays the bill automatically. For example, if the processor 102 retrieves information about a bill from a credit card company, and the currently executing short-term sub-plan estimates all monthly payments be paid in full, the processor 102 schedules a payment to be executed on the due date of the bill between the user's bank and the credit card company. If the user has not paid the bill by the due date, the processor 102 will execute the transaction with pre-authorization from the user. Many such automatic transactions are possible.

Medium-Term Sub-Plan

Preferably, the medium-term sub-plan 220 helps the user plan, manage, analyze, and execute financial flows for the intermediate future. In at least one embodiment, the user sees historical flows for previous months in the current year and estimates flows for 3 months into the future. These future financial flows can be changed manually as well if the user expects a deviation. The system 100 updates transactions from estimated flows to historical flows on a daily basis so that the user sees progress relative to the goal. For example, if the system 100 has estimated a $400.00 monthly expense for food, and the user logs in to the system at the three-quarter month mark and sees a historical expense of $300.00 and an estimated expense of $100.00, the user knows that actual food expenses are converging with the sub-plan and food spending habits need not be changed. Preferably, two configurable variables of the sub-plan are “total base living expenses” and “total variable expenses” so that the user can immediately focus curbing non-essential outflows. In at least one embodiment, the user can select settings such that the system 100 schedules and executes a transaction automatically. For example, if excess savings are currently being used to pay Loan A with an interest rate of 6.00% above the minimum possible payment without incurring penalties, if the user enters a new loan, Loan B, with an interest rate of 10%, and if the currently executing medium-term sub-plan estimates that excess savings should pay only the loan with the highest interest rate above the minimum amount, the processor 102 schedules the excess savings to be paid to Loan B while still maintaining the minimum possible payment on Loan A. If the user has not altered the scheduled transaction by the due date, the processor 102 will execute the transaction with pre-authorization from the user. Many such automatic transactions are possible.

Long-Term Sub-Plan

Preferably, the long-term sub-plan 220 helps the user plan, manage, analyze, and execute financial flows for the future. In at least one embodiment, the user sees historical flows for previous years and estimated flows for the future year. These future financial flows can be changed manually as well if the user expects a deviation. The system 100 monitors trends in flow information so that the user sees progress relative to the long-term goal. For example, if the long-term goal is to acquire one million units of currency, the user sees the rate of savings per year, whether that rate is increasing or decreasing, and whether the user's flows are underperforming or overperforming the long-term flow estimations. As another example, if the long-term goal is to eliminate debt, the user sees the amount of debt reduction per year, whether the rate of debt reduction is increasing or decreasing, and whether the user's flows are underperforming or overperforming the long-term flow estimations. In at least one embodiment, the user can select settings such that the processor 102 schedules and executes a transaction automatically. For example, if current estimated retirement disbursements are $40,000 per year for 10 years, and the processor 102 retrieves data indicating that the user has taken funds out of the user's retirement account, the processor 102 preferably schedules a transaction increasing the contribution to the retirement account such that retirement disbursements re-converge with the estimation of $40,000 per year for 10 years. If the user has not altered the scheduled transaction by the due date, the processor 102 will execute the transaction with preauthorization from the user. Many such automatic transactions are possible.

Reporting

Various reports 216 can be generated by system 100. An expense overview analysis report displays the historical flow data, the estimated flow data, and a comparison between the two. The user sees analysis of all the flow categories on one page as well as information on how well the user is performing relative to the plan. A trend analysis report displays a current-year trend and a year-over-year trend allowing the user to compare the historical flow trend and the estimated flow trend along with the variance between the two. A category analysis report displays graphs for all the flow categories defined in the system 100 and applicable to the user. A cash flow analysis report displays analyses of the liquidity of the user over time. Preferably, the reports display information using graphs and charts rather than only textual information, e.g. a table.

User-Defined Sub-Plans

In at least one embodiment, the financial plan 220 comprises at least one user-defined sub-plan 224. A user-defined sub-plan may be, for example, a mortgage sub-plan, a retirement sub-plan, a credit card sub-plan, a debt sub-plan, a large purchase sub-plan, a lifestyle change sub-plan, a loan sub-plan, etc.

Mortgage Sub-Plan

The mortgage sub-plan 224 preferably utilizes the user's flow data to determine the overall monthly payment the user can afford for the home and execute a strategy for savings. The system 100 generates an estimated affordable home price for the user based on current expenses and excess cash. The user may input a value of a home below the estimate, and the system 100 generates the total monthly cost including taxes, mortgage, etc. For example, if the user inputs a home price, the system 100 determines the estimated monthly costs along with a savings plan for the down payment based on the active plan, e.g. inflows (income, savings, etc.) and outflows (bills, automobile loan, etc.). If this sub-plan is added to the active plan, the processor 102 preferably schedules and executes automatic transfers of inflows to savings accounts according to the determined schedule. Preferably, the system populates the variables with common default values, set by a system administrator, which the user can change. Such variables comprise percentage used as down payment, market mortgage rate estimate, mortgage type, monthly taxes, monthly insurance, monthly PMI, down payment amount, settlement fees, etc. Preferably, the system uses a set of formulas to determine the values of each variable based on minimal user input. If the user has not entered the values of enough variables, the system 100 preferably prompts the user to enter the least number of values to accurately plan and execute the mortgage sub-plan.

Retirement Sub-Plan

The retirement sub-plan 224 preferably utilizes the user's flow data to determine and execute a strategy for retirement. For example, if the user inputs a retirement age, the system 100 determines the savings required to enable the user to retire at the retirement age based on the active plan. Conversely, the system 100 can also calculate the age of retirement based on inflows and savings in the active plan. Preferably, all values are adjusted for inflation. If this sub-plan is added to the active plan, the processor 102 preferably schedules and executes automatic transfers of inflows to retirement accounts according to the determined schedule. Preferably, the system populates the variables with common default values, set by a system administrator, which the user can change. Such variables comprise age, liquid assets, additional assets, savings rate, return rate, fixed living expenses, variable living expenses, retirement age, etc. Preferably, the system uses a set of formulas to determine the values of each variable based on minimal user input. If the user has not entered the values of enough variables, the system 100 preferably prompts the user to enter the least number of values to accurately plan and execute the retirement sub-plan.

Credit Card & Debt Planning

The credit card and debt planning sub-plan 224 preferably utilizes the user's flow data to determine and execute a strategy for eliminating debt. The system 100 outputs to the user the time period and the interest that will be incurred to pay off a credit card or multiple cards. The system 100 also allows the user to view and manage other types of debt. For example, the user specifies a total amount to be reserved to pay all the user's credit cards, and the system 100 generates a payment plan showing the time needed to pay off all of the balances along with the interest rate for each card. Conversely, the user may specify a time period, and the system 100 will generate a payment plan showing the amount needed to payoff each credit card within the time period along with the interest rate for each card. The system 100 also allows the user to input any amount to the total fixed payments for all or each of the credit cards, and the system 100 generates a payment plan showing the reduction in time and interest that will be incurred. If this sub-plan is added to the active plan, the processor 102 preferably schedules and executes automatic transfers of inflows to the appropriate financial institution according to the determined schedule. Preferably, the system 100 populates the variables with common default values, set by a system administrator, which the user can change. Such variables comprise percentage used as name of credit card, balance, effective A.P.R., required minimum monthly payment, etc. Preferably, the system 100 uses a set of formulas to determine the values of each variable based on minimal user input. If the user has not entered the values of enough variables, the system 100 preferably prompts the user to enter the least number of values to accurately plan and execute this sub-plan.

Purchase Planning Sub-Plan

The purchase planning sub-plan preferably utilizes the user's flow data to determine and execute a strategy for saving for a purchase as well as financing the purchase. For example, a purchase may be an automobile, wedding, vacation, etc. The user inputs configurable variables such as price, time period for repayment, interest, down payment, etc. The system 100 calculates the variables not input and generates the planned payment schedule. If this sub-plan is added to the active plan, the processor 102 preferably schedules and executes automatic transfers of inflows to the appropriate financial institution according to the determined schedule. Preferably, the system 100 populates the variables with common default values, set by a system administrator, which the user can change. Such variables comprise total purchase, down payment, interest rate, savings rate, etc. Preferably, the system 100 uses a set of formulas to determine the values of each variable based on minimal user input. If the user has not entered the values of enough variables, the system 100 preferably prompts the user to enter the least number of values to accurately plan and execute this sub-plan.

Lifestyle Change Sub-Plan

The lifestyle change sub-plan 224 preferably utilizes the user's flow data to determine and execute a strategy for a lifestyle change. A lifestyle change, for example, is marriage, birth of a child, divorce, decision to be a saver, etc. Preferably, the lifestyle change sub-plan transitions the user from one set of financial flows to another. For example, the birth of a child may cause the user to want to increase savings each month. Rather than changing the active plan directly, e.g. by adjusting the savings value, the user can change the active plan indirectly by adding the lifestyle change sub-plan. The sub-plan alters the active plan to trend in the direction of the new lifestyle over a period of time. For example, the sub-plan may increase the savings requirement in anticipation of childbirth every month for nine months to allow the user a gradual development into a lifestyle of less outflow and more savings. If this sub-plan is added to the active plan, the processor 102 preferably schedules and executes automatic transfers of inflows to the appropriate financial institution according to the determined schedule. Preferably, the system 100 populates the variables with common default values, set by a system administrator, which the user can change. Such variables comprise total purchase, down payment, interest rate, savings rate, etc. Preferably, the system uses a set of formulas to determine the values of each variable based on minimal user input. If the user has not entered the values of enough variables, the system 100 preferably prompts the user to enter the least number of values to accurately plan and execute this sub-plan.

In some embodiments, the user can enter specific information about a new event into any plan or sub-plan, and the plan or sub-plan will calculate how to pay for the new event based on the new aggregation of information present in the plan or sub-plan. In some embodiments, the user can change information or numbers in a plan or sub-plan at any time during the plan or sub-plan.

Transaction Scheduling and Execution

Preferably, the processor 102 is caused to schedule at least one transaction, inflow or outflow, with at least one financial institution based on the comparison of historical flow information with the previously estimated flow information. For example, if the retirement sub-plan indicates that today is the last day to contribute to the user's 401(k) account for the year, and the latest comparison of historical contributions to the account with estimated contributions for the account indicate the user can still contribute $1,000.00 to the account, the processor 102 schedules a transaction from the user's checking account at the user's bank to the retirement account in the amount of $1,000.00. Many transactions are possible such as withdrawing funds from a financial institution, depositing funds with a financial institution, and transferring funds between financial institutions. In at least one embodiment, the user is notified of the impending transaction via a user-selected method of notification, and the user executes the transaction manually using the system 100. Preferably, if the user takes no action after notification, the transaction is executed by the processor 102 with preauthorization from the user.

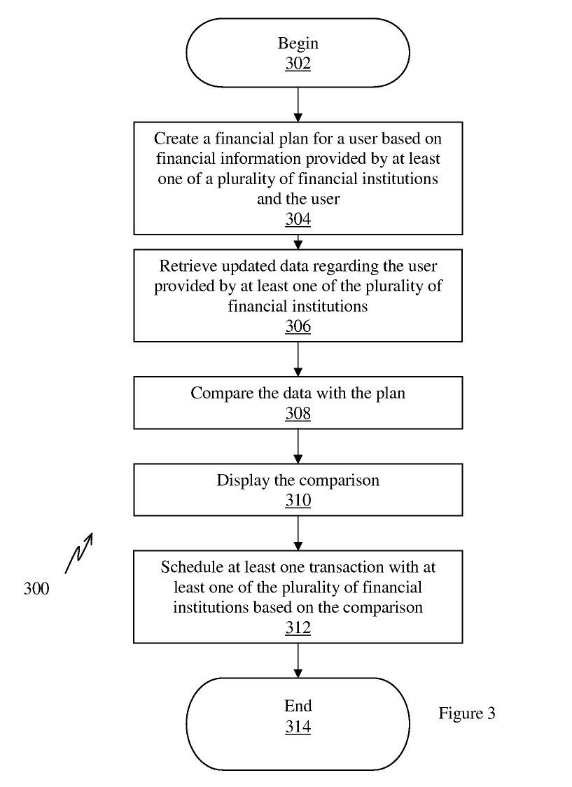

FIG. 3 illustrates a method 300 beginning at 302 and ending at 314. Preferably, the method 300 comprises performing at least one of the steps described in this disclosure. At 304, a financial plan is created for a user based on financial information provided by at least one of a plurality of financial institutions and the user. At 306, updated data regarding the user is retrieved. The data is provided by at least one of the plurality of financial institutions. At 308, the data is compared with the plan. At 310, the comparison is displayed. At 312, at least one transaction with at least one of the plurality of financial institutions is scheduled based on the comparison.

Preferably, the financial plan is modified with at least one sub-plan. For example, adding the sub-plan to the financial plan, deleting the sub-plan from the financial plan, or viewing the impact of the sub-plan on the financial plan. Some examples of sub-plans are a mortgage sub-plan, a retirement sub-plan, a credit card sub-plan, a debt sub-plan, a large purchase sub-plan, a lifestyle change sub-plan, a loan sub-plan, etc.

Returning to FIG. 1B, the system 100 comprises a processor 102 and a memory 106 coupled to the processor. Preferably, the processor 102 performs at least one of the steps described in this disclosure. The processor 102 creates a financial plan for a user based on financial information provided by the user; retrieves data regarding the user provided by at least one of a plurality of financial institutions; compares the data with the plan; outputs for display the comparison; and schedules at least one transaction with at least one of the plurality of financial institutions based on the comparison.

Preferably, the processor 102 modifies the financial plan with a sub-plan. For example, adding the sub-plan to the financial plan, deleting the sub-plan from the financial plan, or viewing the impact of the sub-plan on financial plan. Some example of sub-plans are a mortgage sub-plan, a retirement sub-plan, a credit card sub-plan, a debt sub-plan, a large purchase sub-plan, a lifestyle change sub-plan, a loan sub-plan, etc.

Editorials and Articles

In at least one embodiment, the processor 102 is caused to provide financial education materials to the user. Preferably, the financial education materials comprise editorials 217 about various financial topics and news articles 206, and the materials are provided to even unregistered users. The editorials 217 section preferably offers the user literature in all areas of personal finance: mortgages, credit score/reports, credit cards, banking, automobile financing, personal loans, savings, student loans, taxes, investing, and budgeting/planning. Preferably, the editorials 217 are written by experts, and the editorials are written for the purpose of educating the user. The processor 102 is also caused to provide news articles 206 to the user.

The user accesses the financial education materials by clicking on the title or topic of the material. Preferably, a search function allows the user to search the financial education materials by keyword or topic, and a comment function allows the user to comment on the financial education materials in the form of postings that other users can see. The user is able to select more than one topic, and the system 100 displays all of the relevant materials based on the search criteria. Links to other financial education materials on websites are also provided.

In at least one embodiment, the processor 102 is caused to connect the user with a financial consultant. Preferably, the user connects with the financial consultant via telephone, email, or real-time text (sometimes known as “chatting”), and any documents are transferred via a repository provided by the system, email, or the user's preferred method of notifications. The financial consultants answer questions, complete research projects, and assist users in personal financial needs. For example, a personal financial consultant will negotiate an automobile purchase, finalize the documents associated with the purchase, etc., such that the user is able to accept delivery of the automobile after using only the system 100. In at least one embodiment, the financial consultant will research a financial question from the user and provide answers to the financial question as financial education material.

Preferably, the system 100 conducts all communications in a secure environment. In at least one embodiment, Secure Socket Layer (“SSL”) technology is used, and all confidential data is encrypted before it is stored. For example, the Java Cryptography Extension (“JCE”) support for SSL and Transport Layer Security (“TLS”) protocols with the Java Secure Socket Extension (“JSSE”) is used. Additionally, server authentication, message integrity, and client authentication functionalities are used.

SSL is a protocol that allows web browsers and web servers to communicate over a secured connection. SSL, and thus Hypertext Transfer Protocol over SSL (“HTTPS”), permits encrypted traffic to be exchanged between the client and server. As such, data is encrypted by one party, transmitted, and decrypted by another party before processing. In at least one embodiment, the two parties are in a client/server configuration. For example, the computer displaying the GUI 104 is the client, and server 118 is the server. Preferably, both the server and the client encrypt all traffic before transmission. After the client initiates a conversation with the server, the server sends a security certificate to the client for authentication. The client checks the validity of the certificate. After the certificate is validated, the client generates a premaster secret key, encrypts the key with the server's public key associated with the certificate, and sends the encrypted key to the server. The client and server generate a master key for the session from the premaster key, and use the master key to encrypt communication for the session.

Preferably, the financial plan is currency neutral. Specifically, no monetary units are associated with the numbers used by the system 100. However, in the case where the user has a financial flow in monetary units different from the other financial flows, the user will be able to select in which monetary unit to see the plan or select to view the plan in mixed monetary units. Notifications for the user can be communicated via email, short message service (“SMS”), multimedia message service (“MMS”), a message repository located in the system 100, etc.

Other conditions and combinations of conditions will become apparent to those skilled in the art, including the combination of the conditions described above, and all such conditions and combinations are within the scope of the present disclosure.

In various embodiments, a computer-readable medium 106 comprises volatile memory (e.g., random access memory, etc.), non-volatile storage (e.g., read only memory, Flash memory, hard disk drive, CD ROM, etc.), or combinations thereof. The computer-readable medium 106 comprises software 108 (which includes firmware) that is executed by the processor 102. One or more of the actions described herein are performed by the processor 104 during execution of the software 102.

The above disclosure is meant to be illustrative of the principles and various embodiment of the present invention. Numerous variations and modifications will become apparent to those skilled in the art once the above disclosure is fully appreciated. Also, the order of the actions shown in FIG. 3 can be varied from order shown, and two or more of the actions may be performed concurrently. It is intended that the following claims be interpreted to embrace all variations and modifications.

I claim:

1. A computer-readable medium storing software that, when executed by a processor, causes the processor to:
create a financial plan for a user based on financial information provided by at least one of a plurality of financial institutions and the user;
retrieve updated data regarding the user provided by at least one of the plurality of financial institutions;
compare the data with the plan;
output for display the comparison; and
schedule at least one transaction with at least one of the plurality of financial institutions based on the comparison.

2. The computer-readable medium of claim 1, wherein scheduling the at least one transaction causes the processor to schedule, without input from the user, the at least one transaction with the at least one of the plurality of financial institutions based on the comparison.

3. The computer-readable medium of claim 1, further causing the processor to execute the at least one transaction with preauthorization from the user.

4. The computer-readable medium of claim 1, wherein the financial plan comprises a short-term financial sub-plan, a medium-term financial sub-plan, and a long-term financial sub-plan.

5. The computer-readable medium of claim 1, further causing the processor to connect the user with a financial consultant.

6. The computer-readable medium of claim 1, wherein the financial plan comprises at least one sub-plan selected from the group consisting of a mortgage sub-plan, a retirement sub-plan, a credit card sub-plan, a debt sub-plan, a large purchase sub-plan, a lifestyle change sub-plan, and a loan sub-plan.

7. The computer-readable medium of claim 6, further causing the processor to modify the financial plan with at least one sub-plan, the modification selected from a group consisting of adding the at least one sub-plan to the financial plan, deleting the at least one sub-plan from the financial plan, and viewing impact of the at least one sub-plan on financial plan.

8. The computer-readable medium of claim 1, further causing the processor to connect the user with a researcher that researches a financial question from the user; and
provide answers to the financial question as financial education material.

9. The computer-readable medium of claim 1, wherein the financial plan comprises at least one financial outflow of the user and at least one financial inflow of the user.

10. The computer-readable medium of claim 9, further causing the processor to associate the at least one financial outflow with at least one category of financial outflow selected from the group consisting of mortgage/rent, utilities, automobile, phone, healthcare, food, credit card, loan, entertainment, retail, pet, planned savings, and miscellaneous.

11. The computer-readable medium of claim 9, further causing the processor to associate the at least one financial inflow with at least one category of financial inflow selected from the group consisting of employment, investment, and miscellaneous.

12. The computer-readable medium of claim 9, further causing the processor to split the at least one financial outflow or the at least one financial inflow into a plurality of sub-flows and associate at least two of the plurality of sub-flows with at least two different categories of financial outflow or financial inflow.

13. The computer-readable medium of claim 9, further causing the processor to estimate future financial outflows based on previous financial outflows and estimates future financial inflows based on previous financial inflows.

14. The computer-readable medium of claim 1, wherein creating the financial plan causes the processor to associate the user's financial outflows with categories of financial outflow without input from the user based on a second plurality of data provided by the financial institutions and associate the user's financial inflows with categories of financial inflow without input from the user based on the second plurality of data provided by the financial institutions; any associations configurable by the user.

15. The computer-readable medium of claim 1, wherein the at least one transaction is selected from a group consisting of withdrawing funds from the at least one financial institution, depositing funds with the at least one financial institution, and transferring funds between the at least one financial institution and another at least one financial institution.

16. The computer-readable medium of claim 1, wherein the financial plan is currency neutral.

17. A method, comprising:
creating a financial plan for a user based on financial information provided by at least one of a plurality of financial institutions and the user;
retrieving updated data regarding the user provided by at least one of the plurality of financial institutions;
comparing the data with the plan;
displaying the comparison; and
scheduling at least one transaction with at least one of the plurality of financial institutions based on the comparison.

18. The method of claim 17, further comprising modifying the financial plan with at least one sub-plan, the modification selected from a group consisting of adding the at least one sub-plan to the financial plan, deleting the at least one sub-plan from the financial plan, and viewing impact of the at least one sub-plan on financial plan, the sub-plan selected from the group consisting of a mortgage sub-plan, a retirement sub-plan, a credit card sub-plan, a debt sub-plan, a large purchase sub-plan, a lifestyle change sub-plan, and a loan sub-plan.

19. A system comprising:
a processor; and
a memory coupled to the processor;
wherein the processor
creates a financial plan for a user based on financial information provided by at least one of a plurality of financial institutions and the user;
retrieves updated data regarding the user provided by at least one of the plurality of financial institutions;
compares the data with the plan;
outputs for display the comparison; and
schedules at least one transaction with at least one of the plurality of financial institutions based on the comparison.

20. The system of claim 19, wherein the processor modifies the financial plan with at least one sub-plan, the modification selected from a group consisting of adding the at least one sub-plan to the financial plan, deleting the at least one sub-plan from the financial plan, and viewing impact of the at least one sub-plan on financial plan, the sub-plan selected from the group consisting of a mortgage sub-plan, a retirement sub-plan, a credit card sub-plan, a debt sub-plan, a large purchase sub-plan, a lifestyle change sub-plan, and a loan sub-plan.
